(19) United States
(12) Patent Application Publication
(10) Pub. No.: US 2016/0007063 A1
(43) Pub. Date: Jan. 7, 2016

(54) SYSTEM AND METHOD FOR IDENTIFYING A TARGETED ADDRESSABLE TELEVISION

(71) Applicant: Twenty-Ten, Inc., Toronto (CA)

(72) Inventors: Sheldon H. Smith, Toronto (CA); Kathi Kim-Ellen Hurst, Toronto (CA); Thomas J. Zabrovsky, Toronto (CA); David M. Diamond, New York, NY (US)

(21) Appl. No.: 14/793,177

(22) Filed: Jul. 7, 2015

Related U.S. Application Data
(60) Provisional application No. 62/021,251, filed on Jul. 7, 2014.

(51) Int. Cl. H04N 21/2668; H04N 21/81; H04N 21/658; H04N 21/25; H04N 21/258

(52) U.S. Cl. CPC H04N 21/2668; H04N 21/252; H04N 21/25883; H04N 21/25891; H04N 21/6582; H04N 21/812

(57) ABSTRACT

Computer-implemented systems, methods, and computer-readable media for identifying one or more target consumers associated with an addressable television can include receiving, by at least one of the one or more computing devices, attitudinal data related to at least one product or service, and developing, by at least one of the one or more computing devices, one or more target profiles based at least in part on the attitudinal data. The systems, methods and media can include receiving, by at least one of the one or more computing devices, appended data from the data provider, the appended data including at least one of demographic, behavioral, and locational data corresponding to the plurality of market consumers, and identifying, by at least one of the one or more computing devices, one or more target consumers based on a correlation between the appended data and the one or more target profiles.

### CROSS-REFERENCE TO RELATED APPLICATION

This application claims priority to U.S. Provisional Application No. 62/021,251, filed on Jul. 7, 2014, which is herein incorporated by reference in its entirety.

### SUMMARY

This application discloses an invention which is related, generally and in various embodiments, to a system and method for identifying a targeted addressable television.

Television advertising has, since its inception, relied at least in part on “common sense” to place commercials where they will be seen by the people most likely to purchase the products or services being presented. Often, though, people who are presented with an advertisement have no interest in the product or service being advertised and will not buy it or even pay attention to the advertisement. Presentation of “unwanted” advertising, while having a relatively low cost per exposure, is wasteful in that it uses advertising dollars that could be better spent elsewhere and takes up advertising space and time that could be filled more effectively.

In order to avoid wasteful advertising spending and to more efficiently use advertising time, efforts have been made to target advertising to reach people most likely to respond to it by buying the products or services advertised. Typically, advertising targeting has been based on demographics, such as income and family composition. That is, advertising can be placed within television programs that are assumed to be viewed by people who have the demographic characteristics of likely purchasers. Satellite companies, such as DISH® television and DIRECTV®, and cable companies, such as COMCAST®, have been known to provide such advertising methods or services. Such advertising placement, however, does not alter greatly the likelihood that a large portion of the audience for a particular television program will not be among the target audience (i.e., the likely purchasers) for the advertisement.

Given major advancements in television technology, it is now possible to direct advertising to specific television receivers (e.g., via “set-top” boxes provided to customers by multi-system operators (MSOs), such as cable or satellite television providers). Televisions with the capability of receiving versioned advertising messages via set-top boxes (i.e., Addressable Television) are presently in consumer homes in the tens of millions (approximately 50 million U.S. homes as of the end of 2015). The challenge for advertisers is to identify and reach the televisions that belong to and are viewed by the individuals that advertisers would like to reach. (For the purpose of this application, an addressable television will be assumed to be any suitable television that is capable of the functionality described herein, such as one that is connected to a digital “set-top” box, provided by an MSO, that converts digital signals from the MSO into video and audio signals that can be communicated to consumers on a television receiver, or a television that is configured to received content via the internet, such as an Internet Protocol (IP) television, or the like.)

Attitudinal research is research that seeks to understand what consumers are thinking, not what they are doing. As described in more detail below, attitudinal data is distinct from behavioral and demographic data.

As described herein, aspects of the disclosed embodiments relate to methods, systems and computer-readable media for identifying, based at least in part on attitudinal data, one or more target consumers associated with an addressable television. An exemplary method according to aspects of the disclosed embodiments comprises receiving, by at least one of the one or more computing devices, attitudinal data related to at least one product or service, the attitudinal data corresponding to a plurality of market consumers and identifying each of the plurality of market consumers, developing, by at least one of the one or more computing devices, one or more target profiles based at least in part on the attitudinal data, transmitting, by at least one of the one or more computing devices, information identifying each of the plurality of market consumers to a data provider, receiving, by at least one of the one or more computing devices, appended data from the data provider, the appended data including at least one of demographic, behavioral, and locational data corresponding to the plurality of market consumers, determining, by at least one of the one or more computing devices, a correlation between the appended data and the one or more target profiles, identifying, by at least one of the one or more computing devices, one or more target consumers based on the correlation, each of the one or more target consumers being associated with an addressable television, and transmitting, by at least one of the one or more computing devices, information identifying the one or more target consumers, wherein the information identifying the one or more target consumers is configured to be used to deliver one or more advertisements to one or more addressable televisions.

An exemplary system according to aspects of the disclosed embodiments comprises one or more processors, and one or more memories operatively coupled to at least one of the one or more processors and having instructions stored thereon that, when executed by at least one of the one or more processors, cause at least one of the one or more processors to enable the receipt of attitudinal data related to at least one product or service, the attitudinal data corresponding to a plurality of market consumers and identifying each of the plurality of market consumers, develop one or more target profiles based at least in part on the attitudinal data, enable the transmission of information identifying each of the plurality of market consumers to a data provider, enable the receipt of appended data from the data provider, the appended data including at least one of demographic, behavioral, and locational data corresponding to the plurality of market consumers, determine a correlation between the appended data and the one or more target profiles, identify one or more target consumers based on the correlation, each of the one or more target consumers being associated with an addressable television, and enable the transmission of information identifying the one or more target consumers, wherein the information identifying the one or more target consumers is configured to be used to deliver one or more advertisements to one or more addressable televisions.

An exemplary computer-readable medium according to aspects of the disclosed embodiments is a non-transitory computer-readable medium having computer-readable code stored thereon that, when executed by one or more computing devices, causes at least one of the one or more computing devices to receive attitudinal data related to at least one product or service, the attitudinal data corresponding to a plurality of market consumers and identifying each of the plurality of market consumers, develop one or more target profiles based at least in part on the attitudinal data, transmit information identifying each of the plurality of market consumers to a data provider, receive appended data from the data provider, the appended data including at least one of demographic, behavioral, and locational data corresponding to the plurality of market consumers, determine a correlation between the appended data and the one or more target profiles, identify one or more target consumers based on the correlation, each of the one or more target consumers being associated with an addressable television, and transmit information identifying the one or more target consumers, wherein the information identifying the one or more target consumers is configured to be used to deliver one or more advertisements to one or more addressable televisions.

### BRIEF DESCRIPTION OF THE DRAWINGS

Various embodiments of the invention are described herein by way of example in conjunction with the following figures, wherein like reference characters designate the same or similar elements.

FIG. 1 illustrates an exemplary system according to embodiments of the invention;

FIG. 2 illustrates an exemplary computing system of the system of FIG. 1;

FIG. 3 illustrates an exemplary method according to embodiments of the invention;

FIG. 4 illustrates an exemplary method according to embodiments of the invention; and

FIG. 5 illustrates an exemplary method according to embodiments of the invention.

### DETAILED DESCRIPTION

It is to be understood that at least some of the figures and descriptions of aspects of embodiments of the invention have been simplified to illustrate elements that are relevant for a clear understanding of the invention, while eliminating, for purposes of clarity, other elements that those of ordinary skill in the art will appreciate may also comprise a portion of the invention. However, because such elements are well known in the art, and because they do not facilitate a better understanding of the invention, a description and/or depiction of such elements is not provided herein.

Attitudinal data can be gathered through survey research, but other methods exist for obtaining attitudinal data. Such methods can involve asking consumers what they think and how they feel. In addition to surveys, which can be completed by paper, electronically on a computer, in person and/or over the phone, attitudinal data can be gathered through one or more conversations (e.g., focus groups, one-on-one interviews, etc.) with consumers.

Those skilled in the art would understand that quantitative attitudinal research (e.g., specific answers to specific questions in quantities large enough to analyze and predict, which tend to be surveys) is different from qualitative behavioral research, which is research designed to find new ideas and new directions (which tends to be more open ended and conversation based). Qualitative attitudinal research can be conducted first, and used to develop later, quantitative, survey based attitudinal research, which becomes the basis of the analysis described herein.

In contrast, behavioral data is a record of anything a consumer has ever done, and how and when they did it. For example, behavioral data can include answers to questions such as “what did you buy?” “how often?” “when?” “where?” “what did you look at?” “what did you do Saturday afternoon?” Behavioral data can include answers such as “I went to the store,” and or transactional data such as “I bought a car.” Behavioral data is the “what” and not the “why.” Demographic data is who the consumer is, such as age, income, weight, height, education, etc.

As described in more detail below, aspects of embodiments of the invention can be implemented by a computing device and/or a computer program stored on a computer-readable medium. The computer-readable medium may comprise a disk, a device, and/or a propagated signal.

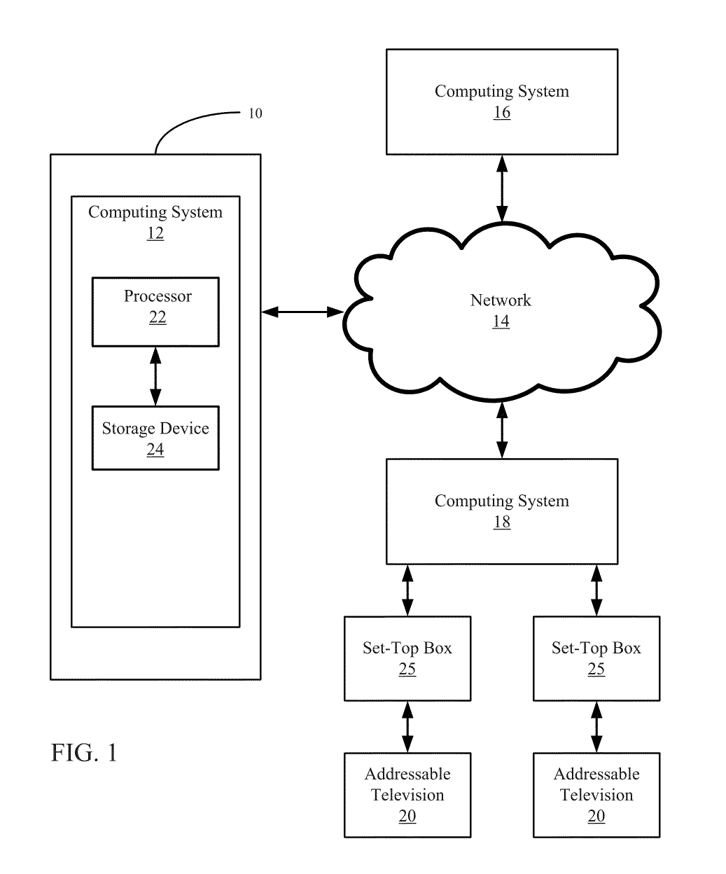

FIG. 1 illustrates various embodiments of a system 10. The system 10 includes a computing system 12 which can be communicably connected to a network 14, which can also be communicably connected to a computing system 16 and a computing system 18. As each of the computing systems 12, 16, 18 can be communicably connected to the network 14, it will be appreciated that the computing system 12 can be communicably connected to the computing systems 16, 18. As shown in FIG. 1, the computing system 18 can be communicably connected to at least one or a plurality of addressable televisions 20 connected to set-top boxes 25. Although only two addressable televisions 20 connected to set-top boxes 25 are shown in FIG. 1 for purposes of simplicity, it will be appreciated that the computing system 18 can be communicably connected to any number of addressable televisions 20 connected to set-top boxes 25. Additionally, although only one network 14, one computing system 16 and one computing system 18 are shown in FIG. 1 for purposes of simplicity, it will be appreciated that the computing system 12 can be communicably connected to any number of networks 14 which in turn can be communicably connected to any number of computer systems 16 and computer systems 18.

As explained in more detail herein, the system 10 can be utilized to identify targeted consumers who have been attitudinally segmented (e.g., segmented based on expressed attitudes, which can be obtained such as through a survey, analyzing the number and/or type of complaints or questions, and/or the like), attitudinally and behaviorally segmented (e.g., segmented based on a combination of (1) expressed attitudes and (2) past behavior), attitudinally and demographically segmented (e.g., segmented based on a combination of (1) expressed attitudes and (2) demographic information), or attitudinally, behaviorally, and demographically segmented (e.g., segmented based on a combination of (1) expressed attitudes, (2) past behavior, and (3) demographic information).

Examples of behavioral data include an individual's type, length and price of a mobile telephone contract, information regarding an individual's lease of an automobile or an apartment, and/or the like. Demographic data can include age, presence of children, age and number of children, income, suburban versus rural or urban location, and/or the like. Behavioral and demographic information are valuable segmentation tools and can be deployed by a variety of industries, such as mini-van manufacturers, as they build addressable media plans. In one embodiment, attitudinal information can be in the form of responses to one or more questions, such as “do you like sweets?” “do you ever diet?” and “what do you think of people who choose not to eat certain foods due to dietary concerns?”.

Information regarding the identified targeted consumers may then be utilized to identify addressable televisions 20 connected to set-top boxes 25 associated with the identified targeted consumers. Once the addressable televisions 20 connected to set-top boxes 25 associated with the identified targeted consumers are identified, versioned advertising messages can be presented to the identified addressable televisions 20 connected to set-top boxes 25 for viewing by the identified targeted consumers (and/or the other members of their household).

The computing system 12 may include any suitable type of computing device (e.g., a server, a desktop, a laptop, etc.) that includes at least one processor. In general, the computing system 12 can be configured to assign prospective consumers into specific attitudinal segments, into specific combinations of attitudinal and behavioral segments, and identify target consumers based on the attitudinal segments or on the specific combinations of attitudinal and behavioral segments. According to various embodiments, the computing system 12 can be configured similarly to the targeting engines disclosed in U.S. Pat. Nos. 7,472,072, 7,835,940 and 7,835,940, as well as those disclosed in U.S. patent application Ser. Nos. 12/869,441, 13/167,899, 13/298,324 and 13/948,489, each of which are owned by the Assignee of the instant application and the contents of which are hereby incorporated by reference in their entireties. Additionally, as shown in FIG. 1, according to aspects of various embodiments, the computing system 12 may also include a storage device 24 communicably connected to the processor 22.

According to aspects of various embodiments, one or more modules can be utilized to realize the functionality of the computing system 12. The modules can be implemented in hardware, firmware, software, and combinations thereof. For embodiments utilizing software, the software may utilize any suitable computer language (e.g., C, C++, Java, JavaScript, Visual Basic, VBScript, Delphi) and can be embodied permanently or temporarily in any type of machine, component, physical or virtual equipment, storage medium, or propagated signal capable of delivering instructions to a device. The modules (e.g., software application, computer program) can be stored on a computer-readable medium (e.g., disk, device, and/or propagated signal) such that when a computer reads the medium, the functions described herein can be performed. Exemplary computer-readable media can be non-transitory.

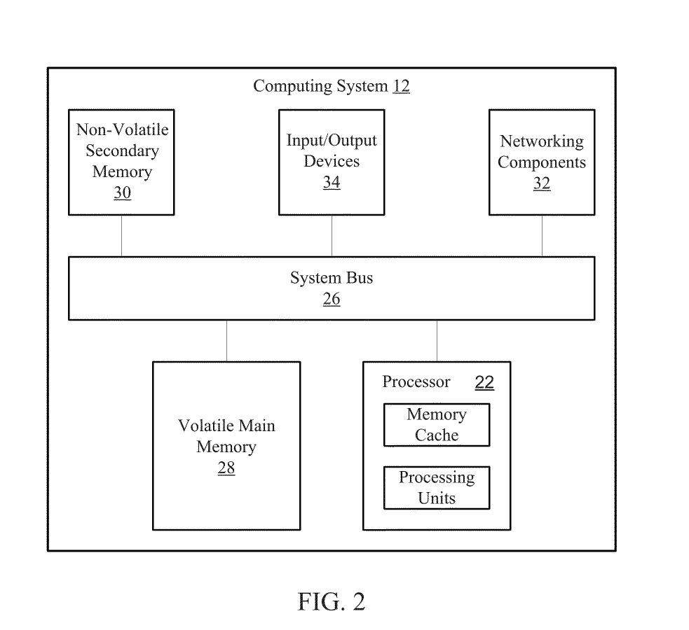

According to aspects of various embodiments, the computing system 12 includes a plurality of modules. According to some embodiments, the functionality of two or more of the modules can be combined into a single module. For embodiments where the computing system 12 includes more than one computing device, the modules can be distributed across two or more of the computing devices. Aspects of various embodiments of the computing system 12 are described in more detail below with respect to FIG. 2.

The network 14 may include one or more networks, and each network may include any type of delivery system including, but not limited to, a local area network (e.g., Ethernet), a wide area network (e.g. the Internet and/or World Wide Web), a telephone network (e.g., analog, digital, wired, wireless, fiber optic, PSTN, ISDN, GSM, GPRS, and/or xDSL), a packet-switched network, a radio network, a television network, a cable network, a satellite network, and/or any other wired or wireless communications network configured to carry data. A given network 14 may include elements, such as, for example, intermediate nodes, proxy servers, routers, switches, and adapters configured to direct and/or deliver data. In general, the system 10 can be structured and arranged to communicate with the computing systems 16, 18 via the one or more networks 14 using various communication protocols (e.g., HTTP, HTTPS, TCP/IP, UDP, WAP, WiFi, Bluetooth) and/or to operate within or in concert with one or more other communications systems.

The computing system 16 may include any suitable type of computing device. For example, according to various embodiments, the computing system 16 may include one or more servers, desktops, laptops, etc. which can be communicably connected to the network 14. The entity associated with the computing system 16 (e.g., a third-party data provider) may utilize the computing system 16 to receive information such as names, addresses and identification numbers from the computing system 12 via the network 14, and to communicate information such as appended variables and identification numbers to the computing system 12 via the network 14. According to aspects of various embodiments, the information communicated between the computing system 12 and the computing system 16 can be communicated in a manner other than via the network 14.

The computing system 18 may include any suitable type of computing device. For example, according to aspects of various embodiments, the computing system 18 may include one or more servers, desktops, laptops, etc. which can be communicably connected to the network 14. The entity associated with the computing system 18 (e.g., an MSO) may utilize the computing system 18 to communicate information such as MSO subscriber lists to the computing system 12 via the network 14, and to receive information such as scored MSO subscriber lists from the computing system 12 (or from another system which utilizes one or more scoring algorithms generally utilized by the computing system 12). Although not shown for purposes of simplicity in FIG. 1, the computing system 18 may also be communicably connected to computing systems of any number of different media agencies, and may receive any number of versioned advertising messages from the computing systems of the media agencies. Once the versioned advertising messages can be received by the computing system 18, the computing system 18 may deliver the messages to the appropriate addressable televisions 20 connected to set-top boxes 25 for viewing by the identified targeted consumers and/or the other members of their respective households.

FIG. 2 illustrates aspects of various embodiments of the computing system 12. The computing system 12 can be embodied as one or more computing devices, and may include networking components 32 such as Ethernet adapters, non-volatile secondary memory 30 such as magnetic disks, input/output devices 34 such as keyboards and visual displays, volatile main memory, and a processor 22. Each of these components can be communicably connected via a common system bus 26. The processor 22 may include processing units and on-chip storage devices such as memory caches.

According to aspects of various embodiments, the computing system 12 may include one or more modules which can be implemented in software, and the software can be stored in non-volatile memory devices 30 while not in use. When the software is needed, the software can be loaded into volatile main memory 28. After the software is loaded into volatile main memory 28, the processor 22 reads software instructions from volatile main memory 28 and performs useful operations by executing sequences of the software instructions on data which can be read into the processor 22 from volatile main memory 28. Upon completion of the useful operations, the processor 22 writes certain data results to volatile main memory 28.

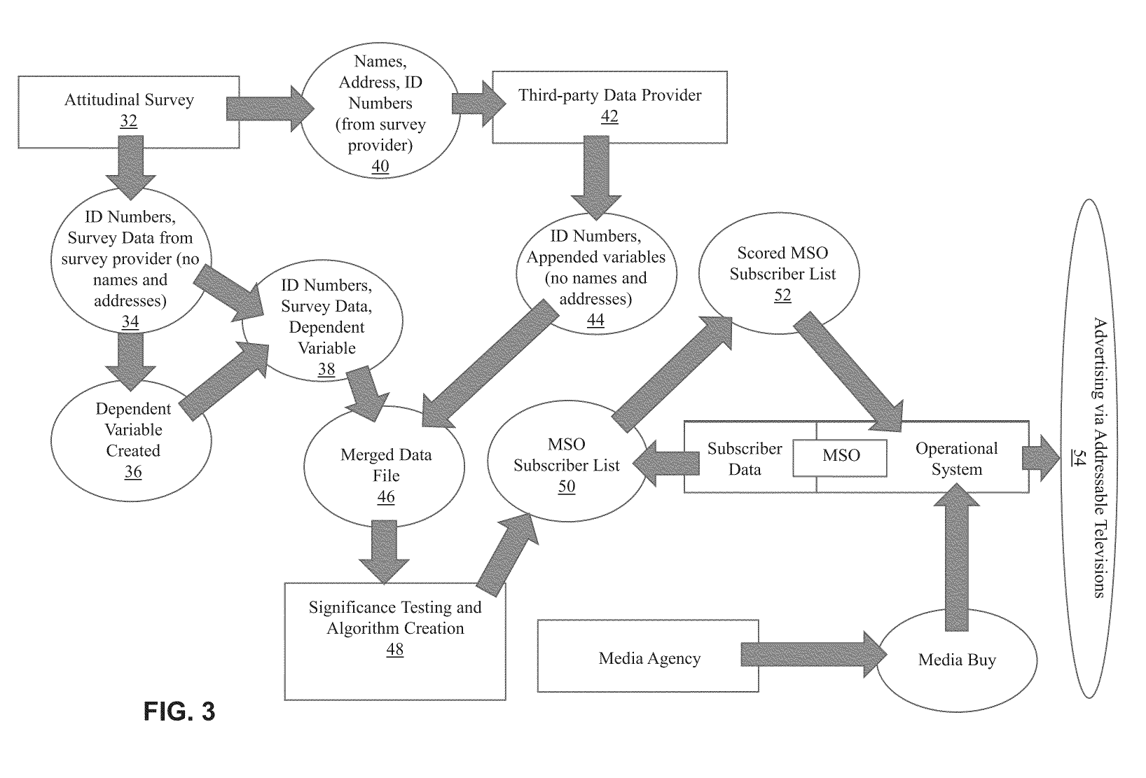

FIG. 3 illustrates aspects of various embodiments of a method 30. The method 30 can be implemented, at least in part, by the computing system 12, and can be utilized to identify targeted consumers, associate specific addressable televisions 20 connected to set-top boxes 25 with the identified targeted consumers, and deliver versioned messages to the addressable televisions 20 connected to set-top boxes 25 associated with the identified targeted consumers. It will be appreciated that the versioned messages delivered to the addressable televisions 20 connected to set-top boxes 25 can be viewed by the identified targeted consumers and/or the other members of their households.

At a high-level, the process typically begins at block 32 with an attitudinal survey that can be related to the products or services the advertiser wishes to promote. The attitudinal survey may ask questions that seek one or more or each of attitudinal, demographical, and/or behavioral information. From block 32, the process can advance to blocks 34 and 40, either simultaneously or at different times. At block 34, the survey responses and identification numbers of the survey respondents (but no names and addresses) can be provided to the computing system 12.

From block 34, the process advances to block 36, where the computing system 12 utilizes the survey responses to develop one or more target profiles. A given target profile can be a description of a given target consumer. For a given target consumer, the target consumer's profile can be created statistically from survey responses. This can be the dependent variable that the computing system's 12 targeting algorithm(s) (targeting equation(s)) will predict. In other words, in aspects of one embodiment, the one or more target profiles can be mathematical representations of the dependent variable. Also, if there are several types of target consumers identified by the survey research, more than one target profile (and consequently more than one dependent variable) will be created. In aspects of the disclosed embodiments, dependent variables are variables that can be based on answers to the questions in the survey. For example, dependent variables can be an individual's propensity to purchase a particular coupon and/or use coupons. From block 36, the process can advance to block 38, where the computing system 12 associates the dependent variables with the identification numbers and the survey data.

At block 40, the names, addresses and identification numbers of the survey respondents (but no survey responses) can be provided to a third-party data provider (e.g., provided to computing system 16), such as Experian, Acxiom, or Epsilon. From block 40, the process can advance to block 42, where the third-party data provider utilizes the information to match specific survey respondents to records in the third-party provider's databases of tens of millions of individuals. Each individual from the survey can be identified by a unique identification number. Once the matching has been completed, the process can advance from block 42 to block 44, where the third-party data provider appends suites of variables (sometimes referred to herein as “appended data”) from their database to the identified individuals from the attitudinal survey. In one embodiment, the suites of variables can include demographic data and/or behavioral data. In addition or alternatively, the suites of variables can include informational data, such as a consumer number, a cable box number, a service address, and/or the like. It will be appreciated that the processes described at blocks 34-38 may occur before, after or concurrently with the processes described at blocks 40-44.

From blocks 38 and 44, the process can advance to block 46, where computing system 12 merges the appended data from block 44, including the unique identifier but minus the names and addresses of the individuals, with the survey data (minus the names and addresses) from block 38 by way of the unique identifier. The merged data file at block 46 can contain both the survey data and the third-party appended data.

From block 46, the process can advance to block 48, where the computing system 12 correlates the dependent variable(s) created at block 36 with the third-party independent variables to determine which of the suites of variables (independent variables) from block 44 are most predictive of the dependent variable(s). In one embodiment, independent variables relate to an individual's lifestyle, such as what type of car does the individual own and/or how much does the individual owe on their home's mortgage. The computing system 12 can then generate equations (e.g., the engine(s)), using the multiple regression technique, that specify the effect of each independent (appended) variable on the dependent variable.

Each of the equations relating to the candidate dependent variables can then be tested to determine how well the equation predicts the target consumer. According to various embodiments, this can be done by first splitting the scores produced by the equation, sorted from high to low, into ten equal parts (e.g., deciles). For each decile, the means of various survey variables related to the target profile can be calculated. Ideally, the means of these survey variables will be highest in the top deciles and will decline gradually to the lowest decile.

Once all of the equations have been tested, the one that provides the greatest “lift” (i.e., the highest means for the pertinent survey variables) in the top deciles will be selected to be applied to a larger database (millions of records from a third-party data provider). The intent is to link the attitudinal survey to the larger database to identify individuals in the larger database who best fit the profile of the target consumer.

From block 48, the process advances by utilizing the targeting algorithm(s) to identify individual television receivers (addressable televisions 20 connected to set-top boxes 25) associated with the identified target consumers. Various television MSOs have established arrangements with third-party data providers for the purpose of delivering advertising to televisions associated with specific individuals. However, such arrangements make use of the demographic and behavioral data resident in the third-party data providers' databases. In one embodiment, the ability to connect attitudinal research to third-party databases resides only in the process described above at blocks 32-48.

Each third-party data provider having arrangements with MSOs either has identified or can identify individuals among the MSOs' subscribers (by matching the MSOs' records to those of the third-party data providers) who own a television receiver connected to a set-top box. These individuals represent a sub-set of the third-party data provider's full database and can be shown as “MSO subscriber list” at block 50.

It is these sub-set individuals who can be targeted by the method 30. The targeting algorithm(s) (equation(s)) generated at block 48 can be applied to any database. In this case, the targeting algorithm(s) would be applied to the television sub-set, represented by the MSO subscriber list at block 50, to generate a scored MSO subscriber list as shown at block 52. This sub-set can be scored in the same way that the third-party data provider's full database can be scored if identifying target consumers using another advertising delivery channel. It will be appreciated that the MSO subscriber list can be scored by the computing system 12 or by another computing system utilizing the targeting algorithm(s) (equation(s)) generated by the computing system 12 at block 48.

Once the sub-set of television owners having set-top boxes has been scored and the best prospects for the purchase of the advertiser's products or services identified, advertising 54 can be delivered directly to specific television receivers for viewing by the identified best prospects and/or the other members of their respective households. As shown in FIG. 3, in one embodiment, a “Media Agency” may provide content, such as advertisements, using a media purchase arrangements (e.g., “Media Buy”). The delivery of the targeted advertising can be done thorough a set-top box (a converter/descrambler) that can be connected to the targeted consumer's television receiver and can be capable of discriminating between valid and invalid receivers (i.e., those that will accept specific codes and those that will reject specific codes). Thus, the advertiser's message can be “addressed” for delivery to some televisions and not to others. The set-top boxes that accept the advertising can be those belonging to individuals identified using the targeting algorithm(s) (i.e., the top deciles of scores).

The delivery of the targeted advertising can be done in different ways. For example, Advertisement A (a targeted advertisement) might be delivered during a regular commercial break in a scheduled television program to targeted televisions with set-top boxes, while non-targeted televisions might receive the standard, non-targeted Advertisement B. An alternative delivery scenario might have a number of different targeted advertisements (related to different targeting models for the same product or service) delivered to televisions with set-top boxes that have been identified by the different targeting models while non-targeted televisions might receive a “standard” advertisement not related to the targeted product or service.

Advertising might also be delivered to specific televisions with set-top boxes via video on demand (VOD). For example, when a targeted cable or television subscriber requests a television program via VOD, a television with a set-top box associated with that subscriber might be presented with targeted Advertisement A; other targeted televisions with set-top boxes might receive a targeted Advertisement B (containing a different message for the same promoted product or service), while non-targeted televisions, with or without set-top boxes, might receive a “standard,” non-targeted advertisement or, perhaps, no advertisement at all. Any of the delivery scenarios described herein may also be applicable to VOD.

In view of the above, it will be appreciated that in order for such advertising to be delivered to televisions associated with targeted individuals according to aspects of the disclosed embodiments, cable and satellite television providers need to be able to direct advertising to specific set-top boxes connected to television receivers.

Up to and including the present time, targeted advertising has relied upon general demographic characteristics to identify television programs or day-parts (time slots in television schedules) to direct advertising to individuals likely to purchase an advertiser's products or services. This can be referred to as focused mass marketing and is rather “blunt” in that it is inefficient.

The development of addressable television has enabled advertisers to refine, somewhat, the way in which advertising can be delivered by matching some of the personal characteristics of MSOs' subscribers who (through the third-party data provider's database), as in focused mass marketing, are likely to purchase an advertiser's products or services. So instead of having an advertisement directed to everyone watching a particular television program, addressable television provides a means to deliver, more effectively than focused mass marketing, advertising only to people (and/or to members of their respective households) who have the demographic characteristics of someone who is likely to purchase.

The disclosed embodiments described herein further refine the addressable television targeting process by connecting attitudes and behaviors of consumers (including the likelihood of purchase) to specific individuals who own televisions with set-top boxes and to whom targeted advertising can be delivered. The disclosed embodiments have the ability to identify specific individuals in a database who are likely to purchase a product or service. Alternatively, the disclosed embodiments can be used to filter demographically targeted individuals so that only those demographically identified individuals who (1) own a television with a set-top box and (2) are likely to purchase (i.e., in the highest deciles of scores) are targeted to receive versioned advertising via their set-top box connected television.

The disclosed embodiments improve upon current targeted advertising using addressable television by providing a more accurate identification of consumers likely to purchase, by using one or more attitudinal targeting algorithms (either alone or in combination with one or more behavioral targeting algorithms), than do current targeting methods, even those employing addressable television, while potentially improving advertisers' return on investment (ROI). While the cost per exposure using the above-described approach can be greater for advertisers than using other types of television advertising, the ROI will also be greater.

Given the way in which the targeting algorithm(s) can be built, using a third-party data supplier's database, the algorithm(s) can be applied to any MSO's subscriber base, as long as that subscriber base can be appended with identical variables from the third-party data supplier's database. A new model does not need to be built for each MSO's subscriber base. This capability can be due to the fact that the targeting algorithm(s) can be built using variables from the third-party data provider's database, not the MSO's subscriber base.

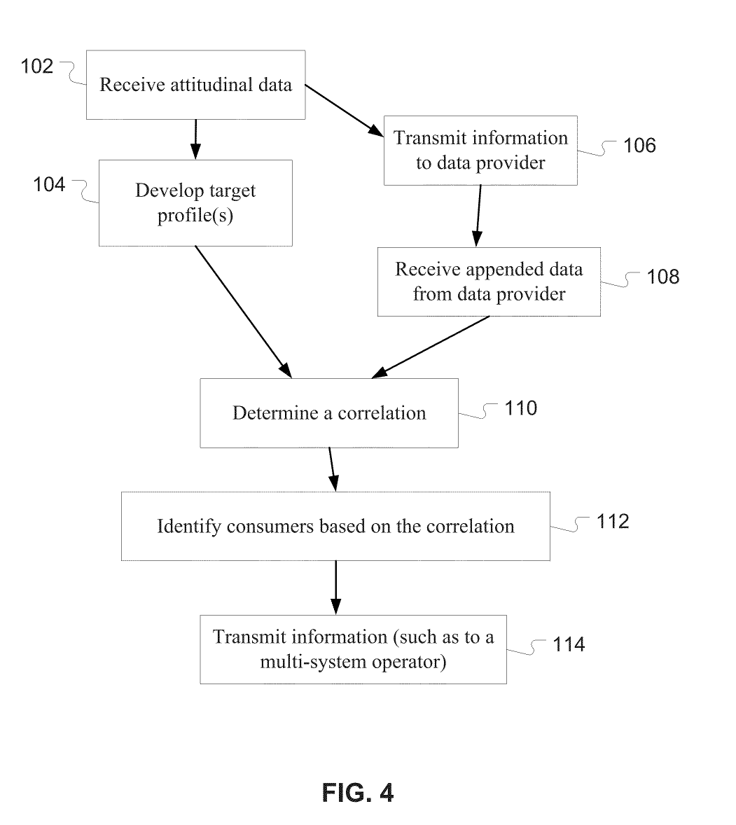

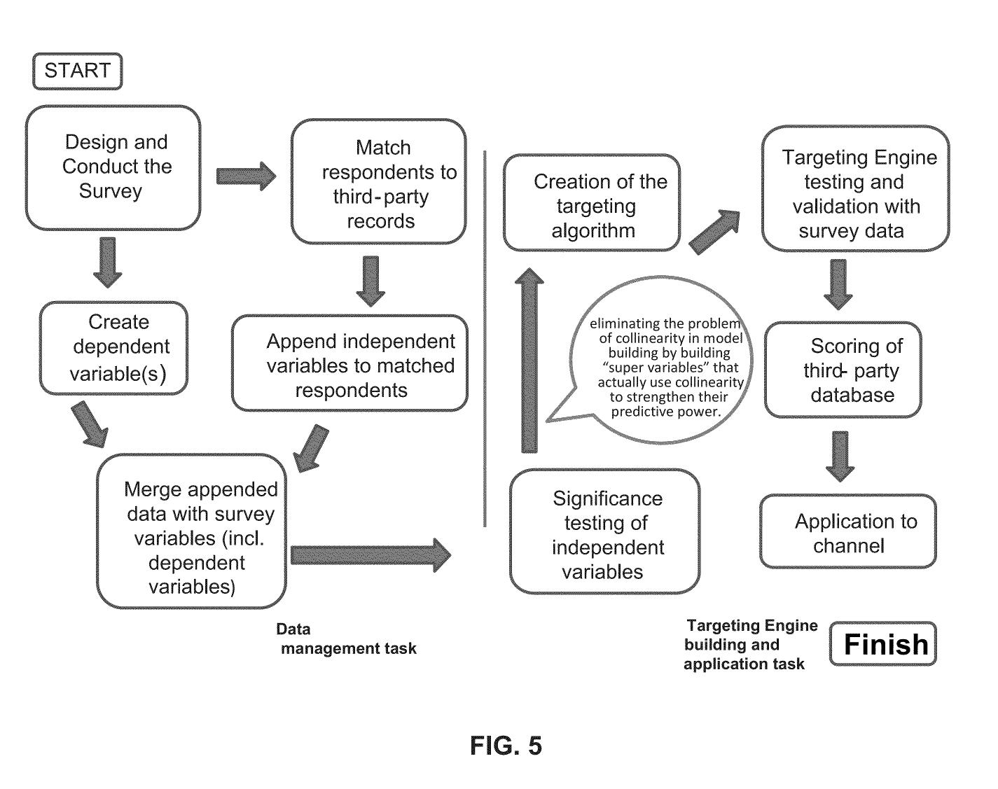

FIGS. 4 and 5 illustrate various methods of disclosed embodiments. Exemplary methods include designing, conducting and/or receiving attitudinal data related to at least one product or service (step 102). The attitudinal data may correspond to a plurality of market consumers and identify each of the plurality of market consumers. The attitudinal data can include one or more or each of survey responses, an identification number, a name, and an address for each of the plurality of market consumers. One or more target profiles can be developed based at least in part on the attitudinal data (step 104).

Information identifying each of the plurality of market consumers can be transmitted to a data provider (step 106). The information transmitted to the data provider can include at least one or more or each of the identification number, the name, and the address for each of the plurality of market consumers. The data provider can match respondents to its records. Appended data may then be received from the data providers (step 108). The appended data can include at least one or two or each of demographic, behavioral, and locational data corresponding to the plurality of market consumers.

A correlation can be determined between the appended data and the one or more target profiles (step 110). Determining a correlation can include generating one or more equations using one or more multiple regression techniques. One or more target consumers can be identified based on the correlation (step 112). Each of the one or more target consumers can be associated with an addressable television. Information identifying the one or more target consumers can be transmitted (step 114). In one embodiment, this information can be transmitted to the data provider and/or the MSO. The information identifying the one or more target consumers can be configured to be used to deliver one or more advertisements to one or more addressable televisions.

Testing can be conducted on each of the one or more equations to determine how well each equation predicts a target consumer associated with an addressable television. The testing can include one or more of splitting scores produced by each equation, sorting the scores from high to low into ten or more equal parts, and comparing the parts to a magnitude of key attributes that comprise the one or more target profiles of the target consumer.

The one or more equations can be applied to a database of addressable televisions. A scored television subscriber list can also be generated. At least one advertisement can be delivered directly to one or more addressable televisions ranked highest on the scored television subscriber list. Addressable televisions that accept the advertisement belong to the one or more target consumers identified using the one or more equations.

As one example, the system and method of the present disclosure can help automobile manufacturers improve the effectiveness of their advertising efforts. Automobile manufacturers may use demographic and behavioral data to target specific ads to specific households.

The above efforts could be improved by adding attitudinal variables, as employed by the system and method of the present disclosure, such as “do you like mini-vans?” “do you see yourself as a mini-van person?” and “what do you think of people who drive mini-vans?”. Answers to the above questions allow for additional targeting and additional versions. For example, consumers who meet the demographic criteria but hate mini-vans would not get an ad, while consumers who meet the demographic criteria but moderately dislike mini-vans would get an ad focused on “the benefits of mini-vans”, and consumers who meet the criteria and love mini-vans get a different ad talking about the ways our mini-van is better than the other mini-vans.

As another example, brewers of beer may use demographics to find their targeted audiences, typically young men for all beers, but more specifically upscale, urban, single men for micro-brews and imports. These demographic sorts have proven effective for well-known micro-brews, such as Sam Adams® and imports like Stella Artois®.

The above efforts could be improved by adding attitudinal segmentation on top of the existing demographic segmentation. Micro-brews may develop a “made in the USA” advertisement for people exhibiting strongly patriotic attitudes, or a “craft brewing” advertisement for people who are interested in artisanal craftsmanship. These are two very different reasons to like the same product. Similarly, imports might segment consumers who love foreign cultures from those who don't care about the foreign countries, but think that “imported” equals “high-quality”. Again, these represent two different reasons to like a specific product category, and specific brands within that category.

Nothing in the above description is meant to limit the invention to any specific materials, geometry, or orientation of elements. Many part/orientation substitutions are contemplated within the scope of the invention and will be apparent to those skilled in the art. The embodiments described herein were presented by way of example only and should not be used to limit the scope of the invention.

Although the invention has been described in terms of particular embodiments in this application, one of ordinary skill in the art, in light of the teachings herein, can generate additional embodiments and modifications without departing from the spirit of, or exceeding the scope of, the described invention. Accordingly, it is understood that the drawings and the descriptions herein are proffered only to facilitate comprehension of the invention and should not be construed to limit the scope thereof.

We claim:

1. A computer-implemented method executed by one or more computing devices for identifying, based at least in part on attitudinal data, one or more target consumers associated with an addressable television, the method comprising:
receiving, by at least one of the one or more computing devices, attitudinal data related to at least one product or service, the attitudinal data corresponding to a plurality of market consumers and identifying each of the plurality of market consumers;
developing, by at least one of the one or more computing devices, one or more target profiles based at least in part on the attitudinal data;
transmitting, by at least one of the one or more computing devices, information identifying each of the plurality of market consumers to a data provider;
receiving, by at least one of the one or more computing devices, appended data from the data provider, the appended data including at least one of demographic, behavioral, and locational data corresponding to the plurality of market consumers;
determining, by at least one of the one or more computing devices, a correlation between the appended data and the one or more target profiles;
identifying, by at least one of the one or more computing devices, one or more target consumers based on the correlation, each of the one or more target consumers being associated with an addressable television; and
transmitting, by at least one of the one or more computing devices, information identifying the one or more target consumers, wherein the information identifying the one or more target consumers is configured to be used to deliver one or more advertisements to one or more addressable televisions.

2. The method of claim 1, wherein the attitudinal data comprises one or more of survey responses, an identification number, a name, and an address for each of the plurality of market consumers, and wherein the information transmitted to the data provider includes at least one of the identification number, the name, and the address for each of the plurality of market consumers.

3. The method of claim 1, wherein the step of determining a correlation includes generating one or more equations using one or more multiple regression techniques.

4. The method of claim 3, further comprising:
testing, by at least one of the one or more computing devices, each of the one or more equations to determine how well each equation predicts a target consumer associated with an addressable television,
wherein testing comprises splitting scores produced by each equation, sorting the scores from high to low into ten or more equal parts, and comparing the parts to a magnitude of key attributes that comprise the one or more target profiles of the target consumer.

5. The method of claim 3, further comprising:
applying, by at least one of the one or more computing devices, the one or more equations to a database of addressable televisions; and
generating, by at least one of the one or more computing devices, a scored television subscriber list.

6. The method of claim 5, further comprising:
delivering, by at least one of the one or more computing devices, at least one advertisement directly to one or more addressable televisions ranked highest on the scored television subscriber list,
wherein addressable televisions that accept the advertisement belong to the one or more target consumers identified using the one or more equations.

7. A system for identifying, based at least in part on attitudinal data, one or more target consumers associated with an addressable television, the system comprising:
one or more processors; and
one or more memories operatively coupled to at least one of the one or more processors and having instructions stored thereon that, when executed by at least one of the one or more processors, cause at least one of the one or more processors to:
enable the receipt of attitudinal data related to at least one product or service, the attitudinal data corresponding to a plurality of market consumers and identifying each of the plurality of market consumers;
develop one or more target profiles based at least in part on the attitudinal data;
enable the transmission of information identifying each of the plurality of market consumers to a data provider;
enable the receipt of appended data from the data provider, the appended data including at least one of demographic, behavioral, and locational data corresponding to the plurality of market consumers;
determine a correlation between the appended data and the one or more target profiles;
identify one or more target consumers based on the correlation, each of the one or more target consumers being associated with an addressable television; and
enable the transmission of information identifying the one or more target consumers, wherein the information identifying the one or more target consumers is configured to be used to deliver one or more advertisements to one or more addressable televisions.

8. The system of claim 7, wherein the attitudinal data comprises one or more of survey responses, an identification number, a name, and an address for each of the plurality of market consumers, and wherein the information transmitted to the data provider includes at least one of the identification number, the name, and the address for each of the plurality of market consumers.

9. The system of claim 7, wherein the instructions that cause at least one of the one or more processors to determine a correlation further cause at least one of the one or more processors to generate one or more equations using one or more multiple regression techniques.

10. The system of claim 9, wherein at least one of the one or more memories has further instructions stored thereon that, when executed by at least one of the one or more processors, cause at least one of the one or more processors to:
test each of the one or more equations to determine how well each equation predicts a target consumer associated with an addressable television,
wherein testing comprises splitting scores produced by each equation, sorting the scores from high to low into ten or more equal parts, and comparing the parts to a magnitude of key attributes that comprise the one or more target profiles of the target consumer.

11. The system of claim 9, wherein at least one of the one or more memories has further instructions stored thereon that, when executed by at least one of the one or more processors, cause at least one of the one or more processors to:
apply the one or more equations to a database of addressable televisions; and
generate a scored television subscriber list.

12. The system of claim 11, wherein at least one of the one or more memories has further instructions stored thereon that, when executed by at least one of the one or more processors, cause at least one of the one or more processors to:
deliver at least one advertisement directly to one or more addressable televisions ranked highest on the scored television subscriber list,
wherein addressable televisions that accept the advertisement belong to the one or more target consumers identified using the one or more equations.

13. A non-transitory computer-readable medium having computer-readable code stored thereon that, when executed by one or more computing devices, causes at least one of the one or more computing devices to:
receive attitudinal data related to at least one product or service, the attitudinal data corresponding to a plurality of market consumers and identifying each of the plurality of market consumers;
develop one or more target profiles based at least in part on the attitudinal data;
transmit information identifying each of the plurality of market consumers to a data provider;
receive appended data from the data provider, the appended data including at least one of demographic, behavioral, and locational data corresponding to the plurality of market consumers;
determine a correlation between the appended data and the one or more target profiles;
identify one or more target consumers based on the correlation, each of the one or more target consumers being associated with an addressable television; and
transmit information identifying the one or more target consumers, wherein the information identifying the one or more target consumers is configured to be used to deliver one or more advertisements to one or more addressable televisions.

14. The computer-readable medium of claim 13, wherein the attitudinal data comprises one or more of survey responses, an identification number, a name, and an address for each of the plurality of market consumers, and wherein the information transmitted to the data provider includes at least one of the identification number, the name, and the address for each of the plurality of market consumers.

15. The computer-readable medium of claim 13, wherein the computer-readable code that causes at least one of one or more computing devices to determine a correlation further causes at least one of one or more computing devices to generate one or more equations using one or more multiple regression techniques.

16. The computer-readable medium of claim 15, the computer readable code further causing at least one of the one or more computing devices to:
test each of the one or more equations to determine how well each equation predicts a target consumer associated with an addressable television,
wherein testing comprises splitting scores produced by each equation, sorting the scores from high to low into ten or more equal parts, and comparing the parts to a magnitude of key attributes that comprise the one or more target profiles of the target consumer.

17. The computer-readable medium of claim 15, the computer readable code further causing at least one of the one or more computing devices to:
apply the one or more equations to a database of addressable televisions; and
generate a scored television subscriber list.

18. The computer-readable medium of claim 17, the computer readable code further causing at least one of the one or more computing devices to:
deliver at least one advertisement directly to one or more addressable televisions ranked highest on the scored television subscriber list,
wherein addressable televisions that accept the advertisement belong to the one or more target consumers identified using the one or more equations.
